(19) United States
(12) Patent Application Publication
(10) Pub. No.: US 2007/0041658 A1
(43) Pub. Date: Feb. 22, 2007

(54) Image matching apparatus, method of matching images, and computer program product

(76) Inventors: Nao Mishima, Kanagawa (JP); Goh Itoh, Tokyo (JP); Masahiro Baba, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/373,988

(22) Filed: Mar. 14, 2006

(30) Foreign Application Priority Data
Aug. 22, 2005 (JP) 2005-240323

(51) Int. Cl. G06K 9/64

(52) U.S. Cl. 382/278

(57) ABSTRACT

An image matching apparatus for obtaining a correspondence relationship between a source image and a destination image, includes an potential force calculator that calculates potential energy based on a correlating relationship of images between each first lattice point on the source image and each second lattice point corresponding one-to-one to the first lattice point on the destination image, and calculates potential force that the second lattice points receives by gradient of the potential energy based on a position of each second lattice point and a position of each first lattice point corresponding to the second lattice point. The potential force calculator sets the potential force calculated last time to the potential force of this time with respect to the second lattice points determined not to execute the calculation process of the potential force.

### CROSS-REFERENCE TO RELATED APPLICATIONS

This application is based upon and claims the benefit of priority from the prior Japanese Patent Application No. 2005-240323, filed on Aug. 22, 2005; the entire contents of which are incorporated herein by reference.

### BACKGROUND OF THE INVENTION

1. Field of the Invention

The present invention relates to an image matching apparatus which detects corresponding points in a source image and a destination image to associate the same with each other, a method of matching images, and computer program product therefor.

2. Description of the Related Art

Image matching is a technique for detecting corresponding points of respective pixels in one source image (starting image) from another destination image (ending image) to find correspondence therebetween. The image matching techniques are utilized in various image processing such as motion detection of moving pictures, stereo matching, image morphing, image recognition, and moving picture encoding.

The image matching techniques can be classified into four main types, i.e., optical flow methods, block-based methods, gradient methods, and Bayesian methods, as disclosed in A. Murat Tekalp, “Digital Video Processing,” Prentice Hall, 1995.

According to the optical flow methods, an optical flow equation is derived based on an assumption of “constant luminance change,” to find the optical flow based on the optical flow equation as a constraint condition. On the other hand, according to the block-based methods, the image is divided into predetermined blocks, and motion is detected according to a template matching for each block. According to the gradient methods, matching is performed in a direction of descent of the luminance gradient in the image. In the Bayesian methods, matching is performed according to probabilistic likelihood.

Another highly robust conventional image matching technique is disclosed in Japanese Patent No. 2927350, where plural multiresolution image pyramids are generated by plural multiresolution filters, and the matching is performed sequentially from an upper layer to a lower layer of the generated image pyramids, thereby allowing for the association of various motions ranging from rough motion to subtle motion of the images.

The conventional image matching techniques, however, are not immune to problems. The optical flow methods, being sensitive to noises by nature, have difficulties in dealing with fast motion. The block-based methods which perform the image matching for each block in the image, though presenting a high reliability in processing of motions such as horizontal translation of an object in the image, basically cannot maintain such a quality when the object in the image is, for example, transformed or rotated. The gradient methods which perform the matching in the direction of descent of the luminance gradient of the image have difficulties in constantly searching the motion of the object. Further, in the Bayesian methods, a global optimal point cannot be determined with ease.

In addition, the technique disclosed in Japanese Patent No. 2927350 essentially requires plural multiresolution filters for the matching of the uppermost layer down to the lowermost layer of the multiresolution image pyramids, which entails difficulties in reduction of computational cost and structural expansion.

Thus, according to the conventional image matching techniques, the reliability of the method can be compromised depending on the presence of noise and motion of the image object. In addition, the improvement in the reliability of the image matching technique inevitably accompanies a further complication of the structure and the process, and ends up in limited expandability.

Further, it is required to efficiently perform the image matching process by decreasing a calculation amount of such image matching process.

### SUMMARY OF THE INVENTION

According to one aspect of the present invention, an image matching apparatus, comprising: a potential force calculator that calculates potential energy based on a correlating relationship of images between each of a plurality of first lattice points on a source image and each of a plurality of second lattice points corresponding one-to-one to the first lattice points on a destination image, and calculates potential force that the second lattice points receives by gradient of the potential energy based on a position of each of the second lattice points and a position of each of the first lattice points corresponding to the second lattice points; a solving process unit that resolves an equation of motion of each of the second lattice points including the potential force by numeric analysis to obtain an convergence state of the second lattice points; a determination unit that determines whether or not to execute a calculation process of the potential force for each of the second lattice points, based on a positional relationship between a current position being a position of a current time in the time of the equation of motion and a reference position being a position of a past time in the time of the equation of motion; a mapping unit that obtains a correspondence relationship between the source image and the destination image based on the equilibrium state of the second lattice points, wherein the potential force calculator sets the potential force calculated last time to the potential force of this time with respect to the second lattice points determined not to execute the calculation process of the potential force by the determination unit.

According to another aspect of the present invention, an image matching method, comprising: calculating potential energy based on a correlating relationship of images between each of a plurality of first lattice points on the source image and each of a plurality of second lattice points corresponding one-to-one to the first lattice points on the destination image; calculating potential force that the second lattice points receives by gradient of the potential energy based on a position of each of the second lattice points and a position of each of the first lattice points corresponding to the second lattice points; resolving an equation of motion of each of the second lattice points including the potential force by numeric analysis to obtain an equilibrium state of the second lattice points; determining whether to execute a calculation process of the potential force or not regarding each of the second lattice points, based on a positional relationship between a current position being a position of a current time in the time of the equation of motion and a reference position being a position of a past time in the time of the equation of motion; obtaining a correspondence relationship between the source image and the destination image based on the equilibrium state of the second lattice points, wherein the potential force calculated last time is set to the potential force of this time, with respect to the second lattice points determined not to execute the calculation process of the potential force by the determination unit.

A computer program product according to still another aspect of the present invention causes a computer to perform the method according to the present invention.

### BRIEF DESCRIPTION OF THE DRAWINGS

FIG. 1 is a block diagram showing a configuration of an image matching apparatus according to a first embodiment;

FIG. 2 is a schematic diagram showing deformed lattice spaces corresponding one-to-one to each other by a point n on the lattice space;.

FIG. 3 is a schematic diagram by explaining a status of a dynamical system regarding a point yn;

FIG. 4 is a schematic diagram showing a concept of image correlating potential force;

FIG. 5 is a schematic diagram showing a concept of image correlating potential force;

FIG. 6 is a schematic diagram showing positional relationships of a point x on a source image object and of a point yn (τ) on a destination image object;

FIG. 7 is a pattern diagram showing a concept of a local optimization;

FIG. 8 is a schematic diagram showing a positional relationship of a point ψ′, which is on the same position as a point ψ by rounding off a pixel position thereof;

FIG. 9 is a flowchart showing procedures of an image matching process by an image matching apparatus 100;

FIG. 10 is a flowchart showing procedures of a calculation process of image correlating potential force according to the first embodiment;

FIG. 11 is a graph showing a result of the image matching process according to the, first embodiment;

FIG. 12 is a block diagram showing a configuration of an image matching apparatus 1200 according to a second embodiment;

FIG. 13 is a pattern diagram showing a difference between the point ψ(=ψ_{1,n}(n)) in an edge region and that in a non-edge region;

FIG. 14 is a flowchart showing procedures of a calculation process of image correlating potential force according to the second embodiment; and

FIG. 15 is a flowchart showing procedures of a calculation process of the image correlation potential according to a third embodiment.

### DETAILED DESCRIPTION OF THE INVENTION

Hereinafter, preferred embodiments of an image matching apparatus, a method of matching images, and an image matching program therefor will be described in detail with reference to accompanying drawings.

Meanwhile, the image matching apparatus according to the embodiments to be described hereinafter can be applied to a motion compensating device for generating a compensated image by performing motion compensation of a motion picture, and in addition, to image processing techniques such as stereo matching, picture morphing, image recognition, and moving picture encoding.

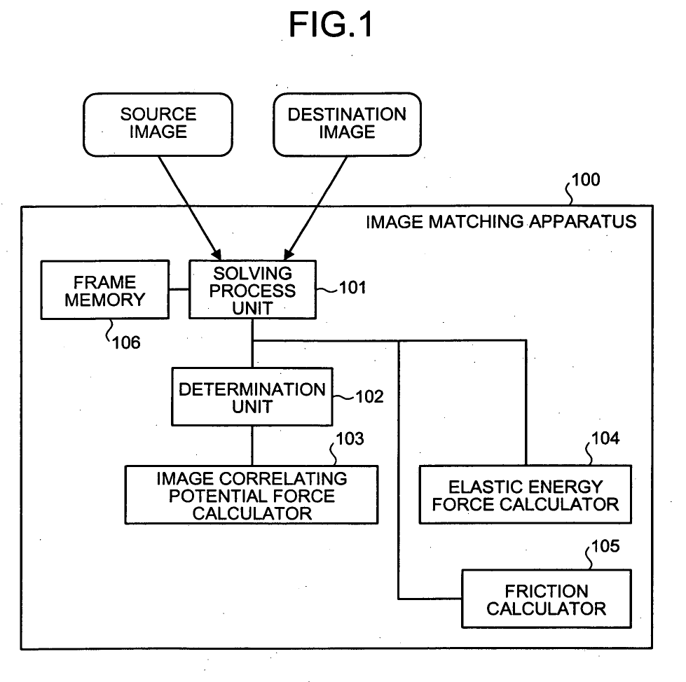

FIG. 1 is a block diagram showing a configuration of an image matching apparatus according to a first embodiment. An image matching apparatus 100 according to this embodiment is configured to input a source image and a destination image to find a correspondence relationship therebetween, and is mainly provided with a solving process unit 101, a determination unit 102, an image correlating potential force calculator 103, an elastic energy force calculator 104, a friction force calculator 105, and a frame memory 106.

In the image matching apparatus 100 according to this embodiment, each of lattice points, which are obtained by dividing each of the source image and the destination image into a predetermined lattice pattern, is assumed to be a mechanical mass point, and first lattice points of the source image and second lattice points of the destination image corresponding one-to-one to the first lattice points are assumed to have image correlating potential energy based on a correlation relationship of the images, and an equation of motion regarding the second lattice points of image correlating potential force received by the second lattice points by gradient of the image correlating potential energy based on the positions of the first lattice points and the second lattice points, elastic energy force received from the elastic energy between the lattice points adjacent to the second lattice points and friction force generated on the second lattice points is set to a image matching state transition model, and an equilibrium state of the second lattice points is found by resolving the equation of motion by using numeric analysis process, thereby finding a mapping between the first lattice points and the second lattice points.

The solving process unit 101 is configured to resolve an equation of motion-regarding the second lattice points of the image correlating potential force received by the gradient of the image correlating potential energy, an elastic energy force received from the elastic energy between the second lattice points and the lattice points adjacent to the same, and the friction force generated on the second lattice points, by the numeric analysis process by using a discrete variable method using the Euler's method to find the equilibrium state of the second lattice points, thereby finding the mapping relationship between the first lattice points and the second lattice points.

The image correlating potential force calculator 103 is configured to calculate image correlating potential force, received by the second lattice points by the gradient of the image correlating potential energy based on the positions of the first and second lattice points.

The elastic energy force calculator 104 is configured to calculate elastic energy force received from the elastic energy between the second lattice points and lattice points adjacent to the same.

The friction force calculator 105 is configured to calculate friction force generated on the second lattice points.

The determination unit 102 is configured, regarding to each of the second lattice points, to compare a current position, which is a position of a current time in the time of the equation of motion, and a reference position, which is a position of a past time in the time of the equation of motion, and to determine not to perform a calculation process of the image correlating potential energy force with respect to the second lattice points, the current positions of which are in the neighborhood of the reference positions. The above-mentioned “time of the equation of motion” is a time τ to be described later. Further, the time in the “time of the equation of motion” corresponds to the number of iterations or the number of steps in a numeric analysis process recurrently performed by the solving process unit 101 to each of the second lattice points.

The determination unit 102 determines that the second lattice points are in the neighborhood of the reference position, for example, when the current position is in a certain range including the reference position. For example, a position of the latest past time and a position of a time at which the image correlating potential energy force is finally calculated can be used as the reference position.

The frame memory 106 is configured to save inputted source image and destination image. Processes of each of the units will be described later in detail.

Next, an image matching state transition model adopted in the image matching apparatus 100 according to this embodiment will be described. As an image targeted in this embodiment, a model represented by Expression (1) is considered:

$${s}_{c} ( x , t ) , [ \begin{matrix}x \\ t\end{matrix} ] ∈ ( X \times T ) ⋐ {R}^{3} \qquad ( 1 )$$

where X⊂R² is a set of an entire of image, and T⊂R is a set of a target time. However, Expression (1) is a model of successive images in a real number space and since a digital image is dealt with in this embodiment, a sampling model represented by Expression (2) is considered:

$${s}_{p} ( x , t ) , [ \begin{matrix}x \\ t\end{matrix} ] = [ \begin{matrix}V & 0 \\ 0 & Δ t\end{matrix} ] [ \begin{matrix}n \\ k\end{matrix} ] ∈ ( N \times K ) ⋐ {Λ}^{3} \qquad ( 2 )$$

where N⊂Λ² is a lattice set of an entire image, K⊂Λ is a lattice set of a target time, and V is a sampling matrix, for example,

$$V = [ \begin{matrix}1 & 0 \\ 0 & 1\end{matrix} ]$$

V is a sampling matrix which connects N to X. Image matching is a problem to find which point on the source image corresponds to which point on the destination image. Herein, an image matching problem can be formulated as a problem to search motion vector d: X×T→X, which satisfies Conditional Equation (3):
sₚ(x,t)=S_{c}(x+d(x,t;1Δt),t+1Δt) (3)
Further, since the motion vector d is a real number, a right-hand member of Conditional Equation (3) uses notation of Equation (1) of the model of successive images. Herein, since the image matching of two images, which are the source image and the destination image, is considered, a problem represented by Equivalent Equation (4-1) is considered:
Sₖ_{₁}_{,p}(x)=Sₖ_{₂}_{,c}(x+d(x)) (4-1)
here,
Sₖ_{₁}_{,p}(x)=Sₚ(x,t)|ₜ₌ₖ_{₁}_{Δt} (4-2)
Sₖ_{₁}_{,c}(x)=S_{c}(x,t)|ₜ₌ₖ_{₂}_{Δt} (4-3)
where k₁,k₂εK are variables each representing the source image and the destination image.

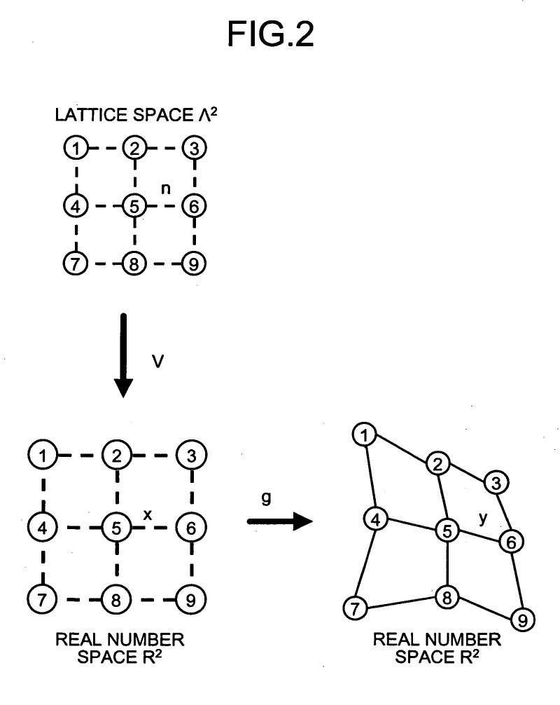

In the model represented by Equation (4-1), the motion vector is simplified to be d: X→X. It is sufficient that a single motion vector d is determined relative to a point x, so that the motion vector d is set to a one-to-one mapping. Herein, since x+d(x) is assumed to be a mapping relative to the point x, it is defined as represented by Equation (5):
g(x)=x+d(x) (5)
where g is the one-to-one mapping of X→X. Further the image matching problem is resulted in a problem to search the mapping g, which satisfies Equation (6):
sₖ_{₁}_{,p}(x)=sₖ_{₂}_{,c}(g(x)) (6)
Herein, a point determined by the mapping g is defined as represented by Expression (7):
y=g(x)
yεX (7)
Since x=Vn, x corresponds one-to-one to a point n on a lattice space. Since the mapping g is one-to-one mapping, y also corresponds one-to-one to x. Therefore, y corresponds one-to-one to n. FIG. 2 is a schematic diagram showing a deformed lattice space which corresponds one-to-one to each other by a point n on the lattice space.
Since y=g(x)=g(Vn), it is defined as represented by Equation (8) to indicate one-to-one correspondence to n:
yₙ=g(x) (8)
By the equation (8), the image matching problem results in a problem to search a point yₙ, which satisfies Equation (9):
sₖ_{₁}_{,p}(x)=sₖ_{₂}_{,c}(yₙ) (9)

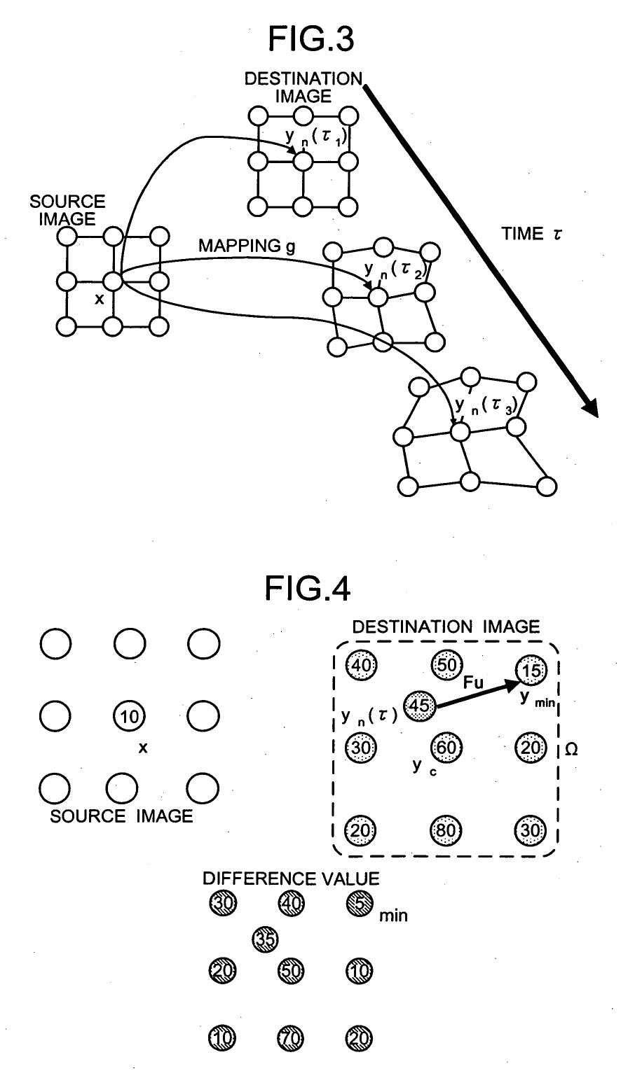

In order to resolve such image matching problem, this is resulted in a problem to resolve a dynamical system regarding the point yₙ. FIG. 3 is a schematic diagram for explaining a status of the dynamical system regarding the point yₙ. As shown in FIG. 3, the point yₙ moves to a status, which satisfies Equation (9), while considering a relationship between adjacent points to converge toward the equilibrium state. In this embodiment, it is considered that the image matching is completed when achieving to the equilibrium state.

A new time axis τ is adopted to the point y to define a function yₙ(τ). Herein, an initial value is supposed to be same as a square lattice x as represented by Equation (10).
yₙ(0)=x (10)

Further it is supposed that yₙ(τ) is converged when τ is infinite, and defined as represented by Equation (11):

$${\ddot{y}}_{n} ( τ ) = F \\ [ \begin{matrix}{y}_{n} & ( 0 ) \\ {\dot{y}}_{n} & ( 0 )\end{matrix} ] = [ \begin{matrix}x \\ 0\end{matrix} ] , ∀ n ∈ N \qquad ( 13 )$$

Herein, a derivative with respect to the time τ is defined by Equation (12):

$${lim}_{τ -> ∞} {y}_{n} ( τ ) = {y}_{nopt} \qquad ( 11 )$$

Generally, the dynamical system is represented by a normal differential equation represented by Equation (13), and Equation (13) is the equation of motion:

$$\frac{ⅆ}{ⅆ τ} {y}_{n} ( τ ) = {\dot{y}}_{n} ( τ ) , \frac{{ⅆ}^{2}}{ⅆ {τ}^{2}} {y}_{n} ( τ ) = {\ddot{y}}_{n} ( τ ) \qquad ( 12 )$$

where FεR² is a sum of force.

When considering about force acting on yₙ(τ), force of the image correlating potential energy (image correlating potential force) which drives the dynamical system is first considered. The image correlating potential force is the force for moving yₙ(τ) to a state which satisfies Equation (9). Equation (14) is obtained by transforming Equation (9):
sₖ_{₂}_{,c}(yₙ)−sₖ_{₁}_{,p}(x)=0 (14)

However, it is difficult to search a point which exactly satisfies Equation (14), due to noise component or the like included in the image, so that an energy function represented by Equation (15) is considered to search a point on which an energy function Eᵤ is the smallest:
Eᵤ(n)=(sₖ_{₂}_{,c}(yₙ(τ))−sₖ_{₁}_{,p}(x))² (15)

When searching the point on which an energy function Eᵤ is the smallest, a steepest descent method principle is used. By using the steepest descent method principle, it is possible to find a local minimum value by descending in steepest descent direction of the energy function Eᵤ in the vicinity of yₙ(τ). Therefore, gradient to the steepest descent direction is defined as force relative to yₙ(τ). The energy function Eᵤ can be considered as correlation of the image, so that the force is set to force Fᵤ by the image correlating potential energy, in this embodiment.

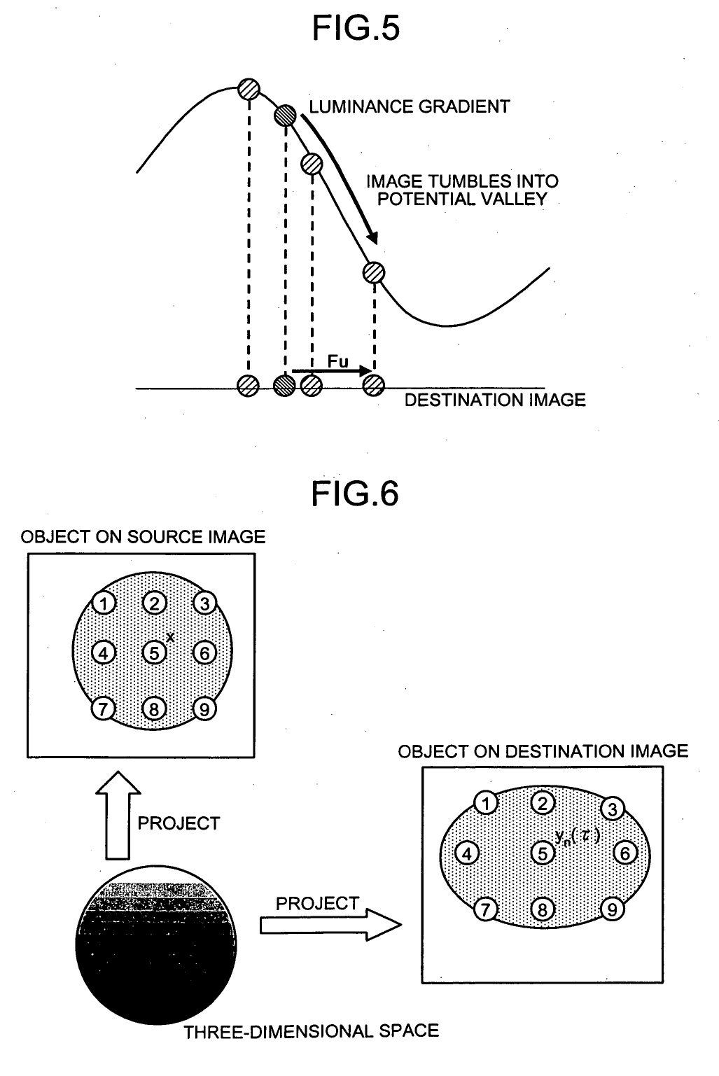

In this embodiment, the gradient to the steepest descent direction is directly found by a method of local optimization. FIGS. 4 and 5 are schematic diagrams showing concept of the image correlating potential force. Herein, the image model S_{c} is a model of successive images. Actually, a sampled image model Sₚ is used, so that the local optimization also is performed based on the sampled image model.

A sampling point, which is the closest to the yₙ(τ) is set to a local space center y_{c}, and y_{c} is found by Equation (16):

$${y}_{c} = ⌊ {y}_{n} ( τ ) + [ \begin{matrix}0.5 \\ 0.5\end{matrix} ] ⌋ \qquad ( 16 )$$

where └.┘ represents an integer (round off) operator

Further, an adjacent space L is defined by Equation (17-1):
Adjacent space

$$L = \{ [ \begin{matrix}- 1 \\ - 1\end{matrix} ] , [ \begin{matrix}0 \\ - 1\end{matrix} ] , [ \begin{matrix}1 \\ - 1\end{matrix} ] , [ \begin{matrix}- 1 \\ 0\end{matrix} ] , [ \begin{matrix}0 \\ 0\end{matrix} ] , [ \begin{matrix}1 \\ 0\end{matrix} ] , [ \begin{matrix}- 1 \\ 1\end{matrix} ] , [ \begin{matrix}0 \\ 1\end{matrix} ] , [ \begin{matrix}1 \\ 1\end{matrix} ] \} \qquad ( 17 \text{-} 1 )$$

Herein, a local search set Ω can be defined as represented by Equation (17-2):
Ω={yₙ(τ),y_{c}+1|∀1εL} (17-2)

Further, after the local optimization, vector in the steepest descent direction is found, and the found vector is normalized and is multiplied by the size of the gradient to obtain Equations (18-1) to (18-3) as the image correlating potential force:

$$\begin{matrix}{F}_{u} ( n , y ( τ ) ) = \frac{{( {s}_{{k}_{2} , c} ( {y}_{min} ) - {s}_{{k}_{2} , c} ( {y}_{c} ( τ ) ) )}^{2}}{‖ {u}_{d} ‖} {u}_{d} & ( 18 \text{-} 1 ) \\ {u}_{d} = {y}_{min} - {y}_{n} ( τ ) & ( 18 \text{-} 2 ) \\ {y}_{min} = arg {min}_{y ∈ Ω} {( {s}_{{k}_{2} , p} ( y ) - {s}_{{k}_{1} , p} ( x ) )}^{2} & ( 18 \text{-} 3 )\end{matrix}$$

In this embodiment, Equations (18-1) to (18-3) are used as the image correlating potential force.

Meanwhile, if the energy function is defined as represented by Equation (19) by considering manageability in mounting or the like, Equations (20-1) to (20-3) are obtained as the image correlating potential force:

$$\begin{matrix}{E}_{u} ( n ) = \vert \vert {s}_{{k}_{2} , c} ( {y}_{n} ( τ ) ) - {s}_{{k}_{1} , p} ( x ) & ( 19 ) \\ {F}_{u} ( n , y ( τ ) ) = \frac{\vert {s}_{{k}_{2} , c} ( {y}_{min} ) - {s}_{{k}_{2} , c} ( {y}_{n} ( τ ) ) \vert}{‖ {u}_{d} ‖} {u}_{d} & ( 20 \text{-} 1 ) \\ {u}_{d} = {y}_{min} - {y}_{n} ( τ ) & ( 20 \text{-} 2 ) \\ {y}_{min} = arg {min}_{y ∈ Ω} \vert {s}_{{k}_{2} , p} ( y ) - {s}_{{k}_{1} , p} ( x ) \vert & ( 20 \text{-} 3 )\end{matrix}$$

Therefore, Equations (20-1) to (20-3) may also be used as the image correlating potential force.

Next, force for describing a relationship between the lattice points and the points adjacent to the same will be described. In this embodiment, the source image of the image matching is considered to be a projection of a three-dimensional space to a two-dimensional image. For example, if an object on the three-dimensional space is a rigid body, a surface of the rigid body is observed as an object on the two-dimensional image. When the object on the three-dimensional space is observed on the source image and the destination image, a phase of the object observed on each of the images may be maintained with high probability. FIG. 6 is a schematic diagram showing positional relationships of the point x on the source image object and of the point yₙ(τ) on the destination image object. As shown in FIG. 6, the positional relationship of the point x on the source image object is maintained by the point yₙ(τ) on the destination image object. Such characteristic allows to describe a relationship between the lattice points and the points adjacent to the same by assuming that a space between the lattice point yₙ(τ) and points adjacent to the same is connected by a spring and elasticity of the spring acts thereon. In this embodiment, the relationship between the lattice point and the points adjacent to the same is described by the elasticity of the spring, that is, elastic energy force Fₖ.

First, a lattice point set Lₙ in the vicinity of a target lattice point is defined. When there are four points in the vicinity, the lattice point set Lₙ is represented by Equation (21):

$${L}_{n} = \{ [ \begin{matrix}0 \\ - 1\end{matrix} ] , [ \begin{matrix}- 1 \\ 0\end{matrix} ] , [ \begin{matrix}1 \\ 0\end{matrix} ] , [ \begin{matrix}0 \\ 1\end{matrix} ] \} \qquad ( 21 )$$

Herein, the elasticity of the spring (elastic energy force) acting on the lattice point yₙ(τ) is represented by Equation (22), in which k is a spring constant:

$${F}_{k} ( n , y ( τ ) ) = {\sum }_{1 ∈ {L}_{n}} k ( {y}_{n + 1} ( τ ) - {y}_{n} ( τ ) ) \qquad ( 22 )$$

Further, when it is assumed that the four points in the vicinity of the lattice point yₙ(τ) are connected, the elastic energy force Fₖ is represented by Equation (23):

$${F}_{k} ( n , y ( τ ) ) = k ( {y}_{n + [ \begin{matrix}0 \\ - 1\end{matrix} ]} ( τ ) - {y}_{n} ( τ ) ) + k ( {y}_{n + [ \begin{matrix}- 1 \\ 0\end{matrix} ]} ( τ ) - {y}_{n} ( τ ) ) + k ( {y}_{n + [ \begin{matrix}1 \\ 0\end{matrix} ]} ( τ ) - {y}_{n} ( τ ) ) + k ( {y}_{n + [ \begin{matrix}0 \\ 1\end{matrix} ]} ( τ ) - {y}_{n} ( τ ) ) \qquad ( 23 )$$

Next, force which scatters energy kept in the lattice points will be described. When the force acting on the lattice point yₙ(τ) is only the image correlating potential force and the elastic energy force, the energy is kept, so that the dynamical system of the lattice point yₙ(τ) is in an oscillating steady state. Therefore, in this embodiment, force which scatters the energy kept in the lattice point yₙ(τ) is adopted, and the friction force acts as such force. When velocity of the lattice point yₙ(τ) is enough small, the friction force is represented by Equation (24):
F_{μ}(\dot{y}ₙ(τ))=−μ\dot{y}ₙ(τ) (24)
where μ(>0) is a dynamical friction coefficient.

When the equation of motion with respect to the lattice point yₙ(τ) is generated as the transition model of the image matching state by using the above-described image correlating potential force Fᵤ, elastic energy force Fₖ, friction force F_{μ}, it is represented by Equations (25-1) and (25-2):

$$\begin{matrix}{\ddot{y}}_{n} ( τ ) = {F}_{u} ( n , y ( τ ) ) + {F}_{k} ( n , y ( τ ) ) + {F}_{μ} ( {\dot{y}}_{n} ( τ ) ) & ( 25 \text{-} 1 ) \\ [ \begin{matrix}{y}_{n} ( 0 ) \\ {\dot{y}}_{n} ( 0 )\end{matrix} ] = [ \begin{matrix}x \\ 0\end{matrix} ] , \\ ∀ n ∈ N & ( 25 \text{-} 2 )\end{matrix}$$

In this embodiment, the image correlating potential force Fᵤ represented by Equations (18-1), (18-2) and (18-3) is calculated by the image correlating potential force calculator 103, the elastic energy force Fₖ represented by Equation (23) is calculated by the elastic energy force calculator 104, and the friction force F_{μ} represented by Equation (24) is calculated by the friction force calculator 105. Further, the equation of motion represented by Equations (25-1) and (25-2) is resolved by the solving process unit 101 by using the numeric analysis process to find mapping between the lattice points of the source image and those of the destination image.

Next, the solution method of the equation of motion by the solving process unit 101 will be described. In general, the equation of motions represented by Equations (25-1) and (25-2), that is, ordinary differential equations, cannot be analytically resolved, so that, time T, which is large enough for the system of the equation of motion to converge, is considered, and conversion status of the equation of motion is estimated by calculating t=(0, T) zone by the numeric analysis.

In this embodiment, the numeric analysis process by the Euler's method is performed by using that the solution of the ordinary differential equation is found one-to-one by the discrete variable method, once an initial value is set.

Meanwhile, although the numeric analysis process is performed by the Euler's method in this embodiment, the process is not limited to this. As the discrete variable method, there are a variety of methods such as the Runge-Kutta method, the Bulirsch-Stoer method, the predictor-corrector method, the implicit Runge-Kutta method, and the like, so that any of these methods can be used as the numeric analysis process. Hereinafter, the numeric analysis process using the Euler's method will be described as an example.

Since the Euler's method is the numeric solution method with respect to a first order normal differential equation, by applying a variable transformation represented by Equation (26) to the equation of motion represented by Equations (25-1) and (25-2), Equations (25-1) and (25-2) are converted into the first order normal differential equations:

$$\{ \begin{matrix}{ψ}_{1 , n} ( τ ) = {y}_{n} ( τ ) \\ {ψ}_{2 , n} ( τ ) = {\dot{y}}_{n} ( τ )\end{matrix} \qquad ( 26 )$$

Thereby, Equations (27-1) and (27-2) are obtained:

$$\begin{matrix}[ \begin{matrix}{\dot{ψ}}_{1 , n} ( τ ) \\ {\dot{ψ}}_{2 , n} ( τ )\end{matrix} ] = [ \begin{matrix}{ψ}_{2 , n} ( τ ) \\ {F}_{u} ( n , {ψ}_{1} , ( τ ) ) + {F}_{k} ( n , {ψ}_{1} , ( τ ) ) + {F}_{μ} ( {ψ}_{2 , n} ( τ ) )\end{matrix} ] , \\ ∀ n ∈ N & ( 27 \text{-} 1 ) \\ [ \begin{matrix}{ψ}_{1 , n} ( 0 ) \\ {ψ}_{2 , n} ( 0 )\end{matrix} ] = [ \begin{matrix}Vn \\ 0\end{matrix} ] & ( 27 \text{-} 2 )\end{matrix}$$

where ψ_{1,n}(τ) and ψ_{2,n}(τ) are position and velocity of yₙ(τ), respectively

On the other hand, when Ordinary Differential Equation (28) is resolved by performing the numeric analysis process by the Euler's method, a solution is developed from t^{(m)} to t^{(m+1)}=t^{(m)}+h as represented by Equation (29):
\dot{x}(t)=F(x(t),t) (28)
x^{(m+1)}=x^{(m)}+hF(x^{(m)},t) (29)
where x^{(m)} represents that the number of steps is m, and h represents a step width. When applying a scheme of the Euler's method to Equations (27-1) and (27-2), Update Equations (30-1) and (30-2) are obtained:

$$\begin{matrix}[ \begin{matrix}{ψ}_{1 , n}^{( m + 1 )} \\ {ψ}_{2 , n}^{( m + 1 )}\end{matrix} ] = [ \begin{matrix}{ψ}_{1 , n}^{( m )} + h {ψ}_{2 , n}^{( m )} \\ {ψ}_{2 , n}^{( m )} + h [ {F}_{u} ( n , {ψ}_{1 , \cdot }^{( m )} ) + {F}_{k} ( n , {ψ}_{1 , \cdot }^{( m )} ) + {F}_{μ} ( {ψ}_{2 , n}^{( m )} ) ]\end{matrix} ] , \\ ∀ n ∈ N & ( 30 \text{-} 1 ) \\ [ \begin{matrix} {ψ}_{1 , n}^{( 0 )} \\ {ψ}_{2 , n}^{( 0 )}\end{matrix} ] = [ \begin{matrix}Vn \\ 0\end{matrix} ] & ( 30 \text{-} 2 )\end{matrix}$$

In this embodiment, the conversion status of the system of the equations of motion (25-1) and (25-2) is found by the solving process unit 101 by repeatedly resolving the update equations of Equations (27-1) and (27-2).

Next, a determination process whether to execute or not the image correlating potential force calculation process by the determination unit 102 will be described. A calculation amount of the image correlating potential force Fᵤ is huge as seen from Equations (18-1), (18-2) and (18-3), and causes an increase of the calculating time of an entire image matching process. Therefore, in this embodiment, it is determined whether to perform or not the calculation of the image correlating potential force Fᵤ, and if it is not performed, the solution process of the equations of motion (25-1) and (25-2) is performed by using the last image correlating potential force Fᵤ to reduce the calculation amount.

The image correlating potential force Fᵤ is represented by Equations (31-1) to (31-6):

$$\begin{matrix}{F}_{u} ( n , {ψ}_{1}^{( m )} ) = \frac{{( {s}_{{k}_{2} , c} ( {y}_{min} ) - {s}_{{k}_{2} , c} ( {ψ}_{1 , n}^{( m )} ) )}^{2}}{‖ {u}_{d} ‖} {u}_{d} & ( 31 \text{-} 1 ) \\ {u}_{d} = {y}_{min} - {ψ}_{1 , n}^{( m )} & ( 31 \text{-} 2 ) \\ {Y}_{min} = arg {min}_{y ∈ Ω} {( {s}_{{k}_{2} , p} ( y ) - {s}_{{k}_{1} , p} ( Vn ) )}^{2} & ( 31 \text{-} 3 ) \\ Ω = \{ {ψ}_{ 1 , n}^{( m )} , {y}_{c} + 1 \text{\textbar} ∀ 1 ∈ L \} & ( 31 \text{-} 4 ) \\ {y}_{c} = ⌊ {ψ}_{ 1 , n}^{( m )} + [ \begin{matrix}0.5 \\ 0.5\end{matrix} ] ⌋ & ( 31 \text{-} 5 ) \\ L = \{ [ \begin{matrix}- 1 \\ - 1\end{matrix} ] , [ \begin{matrix}0 \\ - 1\end{matrix} ] , [ \begin{matrix}1 \\ - 1\end{matrix} ] , [ \begin{matrix}- 1 \\ 0\end{matrix} ] , [ \begin{matrix}0 \\ 0\end{matrix} ] , [ \begin{matrix}1 \\ 0\end{matrix} ] , [ \begin{matrix}- 1 \\ 1\end{matrix} ] , [ \begin{matrix}0 \\ 1\end{matrix} ] , [ \begin{matrix}1 \\ 1\end{matrix} ] \} & ( 31 \text{-} 6 )\end{matrix}$$

Herein, Equation (31-3) is a portion to perform a local optimization, and controls a major part of the calculation amount of the image correlating potential force Fᵤ. The local optimization is a process (calculation) to search an optimal lattice point in the search set Ω represented by Equations (32-1) to (32-3):

$$\begin{matrix}Ω = \{ {ψ}_{1 , n}^{( m )} , {y}_{c} + 1 \text{\textbar} ∀ 1 ∈ L \} & ( 32 \text{-} 1 ) \\ {y}_{c} = ⌊ {ψ}_{ 1 , n}^{( m )} + [ \begin{matrix}0.5 \\ 0.5\end{matrix} ] ⌋ & ( 32 \text{-} 2 ) \\ L = \{ [ \begin{matrix}- 1 \\ - 1\end{matrix} ] , [ \begin{matrix}0 \\ - 1\end{matrix} ] , [ \begin{matrix}1 \\ - 1\end{matrix} ] , [ \begin{matrix}- 1 \\ 0\end{matrix} ] , [ \begin{matrix}0 \\ 0\end{matrix} ] , [ \begin{matrix}1 \\ 0\end{matrix} ] , [ \begin{matrix}- 1 \\ 1\end{matrix} ] , [ \begin{matrix}0 \\ 1\end{matrix} ] , [ \begin{matrix}1 \\ 1\end{matrix} ] \} & ( 32 \text{-} 3 )\end{matrix}$$

where search point is a corresponding point itself, and search point y_{c}+1|∀1εL is a pixel position in the vicinity of the corresponding point

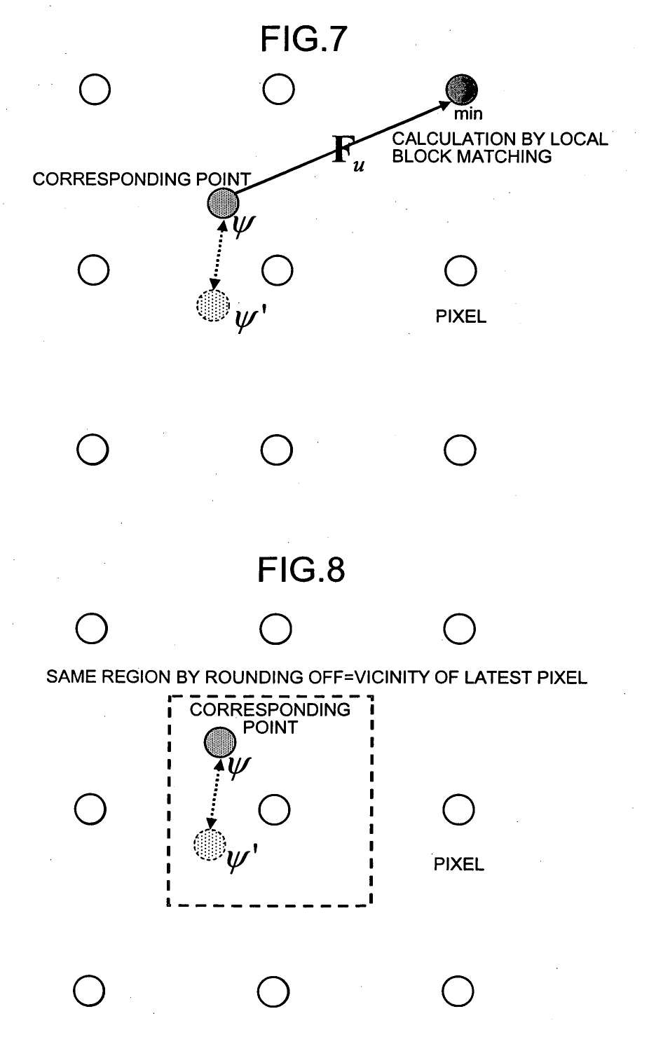

FIG. 7 is a schematic view showing a concept of the local optimization. As shown in FIG. 7, the search point Ψ(=Ψ_{1,n}^{(m)}) indicates the corresponding point itself, and the search point Ψ′ indicates the pixel point in the vicinity of the corresponding point.

Herein, a second lattice point Ψ′(=Ψ′_{1,n}^{(m)}), which is positioned minutely differently from the second lattice point Ψ(=Ψ_{1,n}^{(m)}) of the destination image but is on the same position by rounding off the pixel position thereof, is considered. Herein, the second lattice point Ψ(=Ψ_{1,n}^{(m)}) is the second lattice point of a first time in the time of the above-described equation of motion, and the second lattice point Ψ′(=Ψ′_{1,n}^{(m)}) is the second lattice point of a second time in the time of the above-described equation of motion (that is, the second lattice point in a step different from a numeric analysis process step relative to the second lattice point Ψ(=Ψ_{1,n}^{(m)}) by the solving process unit 101). FIG. 8 is a schematic diagram showing a positional relationship of the point Ψ′, which is on the same position as the point Ψ by rounding off the pixel position thereof. Such point Ψ′, which is on the same position as the point Ψ by rounding off the pixel position thereof means the vicinity of the pixel which is the closest to the point Ψ. Herein, a new search set, the center of which is the point Ψ′(=Ψ′_{1,n}^{(m)}) is represented by Equations (33-1) to (33-3):

$$\begin{matrix}{Ω}^{′} = \{ {ψ}_{1 , n}^{′ ( m )} , {y}_{c}^{′} + 1 \text{\textbar} ∀ 1 ∈ L \} & ( 33 \text{-} 1 ) \\ {y}_{c}^{′} = ⌊ {ψ}_{1 , n}^{′ ( m )} + [ \begin{matrix}0.5 \\ 0.5\end{matrix} ] ⌋ & ( 33 \text{-} 2 ) \\ L = \{ [ \begin{matrix}- 1 \\ - 1\end{matrix} ] , [ \begin{matrix}0 \\ - 1\end{matrix} ] , [ \begin{matrix}1 \\ - 1\end{matrix} ] , [ \begin{matrix}- 1 \\ 0\end{matrix} ] , [ \begin{matrix}0 \\ 0\end{matrix} ] , [ \begin{matrix}1 \\ 0\end{matrix} ] , [ \begin{matrix}- 1 \\ 1\end{matrix} ] , [ \begin{matrix}0 \\ 1\end{matrix} ] , [ \begin{matrix}1 \\ 1\end{matrix} ] \} & ( 33 \text{-} 3 )\end{matrix}$$

As described above, the point Ψ′(=Ψ′_{1,n}^{(m)}) is located on the position in which the pixel position of the Ψ(=Ψ_{1,n}^{(m)}) is rounded off, so that this has a relationship as represented by Equation (34):

$$⌊ {ψ}_{ 1 , n}^{( m )} + [ \begin{matrix}0.5 \\ 0.5\end{matrix} ] ⌋ = ⌊ {ψ}_{ 1 , n}^{′ ( m )} + [ \begin{matrix}0.5 \\ 0.5\end{matrix} ] ⌋ \qquad ( 34 )$$

Therefore, Equation (35) is established:
y_{c}=y′_{c} (35)

Therefore, the search set Ω′ is equivalent to the set represented by Equation (36):
Ω′={ψ′_{1,n}^{(m)},y_{c}+1|∀1εL} (36)
Equation (36) means that the search sets Ω and Ω′ are each composed of ten elements but nine of them are same.

Further, suppose that pixel values of the point Ψ′_{1,n}^{(m)} and Ψ_{1,n}^{(m)} are closely related, search results in the search sets Ω and Ω′ are the same with high probability, that is, on the point Ψ′_{1,n}^{(m)} in the neighborhood of the pixel position which is the closest to the point Ψ_{1,n}^{(m)}, results of the local optimization are the same with high probability. Therefore, using a characteristic of the point Ψ_{1,n}^{(m)} which is the closest to the point Ψ′_{1,n}^{(m)} allows to reduce the calculation amount while maintaining a high accuracy.

So, in this embodiment, the second lattice point Ψ_{1,n}^{(m)}, which is the second lattice point of the first time in the time of the above-described equation of motion and the second lattice point Ψ_{1,n}^{(m+1)}, which is the second lattice point of the second time in the time of the above-described equation of motion (that is, the second lattice point Ψ_{1,n}^{(m+1)} in the step different from the numeric analysis process step relative to the second lattice point Ψ_{1,n}^{(m)} by the solving process unit 101) are taken, and it is determined whether the point Ψ_{1,n}^{(m+1)} will be the same as the point Ψ_{1,n}^{(m)} by rounding off or not (that is, whether the point Ψ_{1,n}^{(m+1)} is in the neighborhood of the latest pixel Ψ_{1,n}^{(m)} or not) by the determination unit 102. When they are the same, it is determined that the point Ψ_{1,n}^{(m+1)} is in the neighborhood of the latest pixel, and the calculation result of the image correlating potential force of the last point Ψ_{1,n}^{(m-1)} is used without calculating the local optimization by the image correlating potential force calculator 103. The determination by the determination unit 102 whether it is in the neighborhood of the latest pixel or not is performed by using Equation (37):

$${ϕ}^{( m + 1 )} ( n ) = \{ \begin{matrix}1 & ⌊ {ψ}_{1 , n}^{( m + 1 )} + {( 0.5 , 0.5 )}^{T} ⌋ = ⌊ {ψ}_{1 , n}^{( m )} + {( 0.5 , 0.5 )}^{T} ⌋ \\ 0 & otherwise\end{matrix} \qquad ( 37 )$$

Meanwhile, although it is determined whether the point Ψ_{1,n}^{(m+1)} is the same as the point Ψ_{1,n}^{(m)} or not by the determination unit 102 by using Equation (37) in this embodiment, it may be configured to use the calculating result of the image correlating potential force of the latest point Ψ_{1,n}^{(m-1)} without calculating the local optimization by the image correlating potential force calculator 103. In this case, the determination by the determination unit 102 is performed by using Equation (38):

$${ϕ}^{( m + 1 )} ( n ) = \{ \begin{matrix}1 & ‖ {ψ}_{1 , n}^{( m + 1 )} - {ψ}_{1 , n}^{( m )} ‖ < ɛ \\ 0 & otherwise\end{matrix} \qquad ( 38 )$$

where ε(>0) is a constant small enough.

The update equations of the image correlating potential force, reflecting such determination result are represented by Equations (39-1) to (39-6). In the image correlating potential force calculator 103 in this embodiment, the image correlating potential force is calculated by using Equations (39-1) to (39-6):

$$\begin{matrix}{F}_{u} ( n , {ψ}_{1 ,}^{( m )} ) = \frac{{( {s}_{{k}_{2} , c} ( {y}_{min} ) - {s}_{{k}_{2} , c} ( {ψ}_{1 , n}^{( m )} ) )}^{2}}{‖ {u}_{d} ‖} {u}_{d} & ( 39 \text{-} 1 ) \\ {u}_{d} = {y}_{min} - {ψ}_{1 , n}^{( m )} & ( 39 \text{-} 2 ) \\ {y}_{min} = \begin{matrix}arg {min}_{y ∈ Ω} {( {s}_{{k}_{2} , p} ( y ) - {s}_{{k}_{1} , p} ( Vn ) )}^{2} & if & {}^{( m )} ( n ) = 0 \\ {y}_{min}^{( m - 1 )} & if & {ϕ}^{( m )} ( n ) = 1\end{matrix} & ( 39 \text{-} 3 ) \\ Ω = \{ {ψ}_{1 , n}^{( m )} , {y}_{c} + 1 \vert ∀ 1 ∈ L \} & ( 39 \text{-} 4 ) \\ {y}_{c} = ⌊ {ψ}_{1 , n}^{( m )} + [ \begin{matrix}0.5 \\ 0.5\end{matrix} ] ⌋ & ( 39 \text{-} 5 ) \\ L = \{ [ \begin{matrix}- 1 \\ - 1\end{matrix} ] , [ \begin{matrix}0 \\ - 1\end{matrix} ] , [ \begin{matrix}1 \\ - 1\end{matrix} ] , [ \begin{matrix}- 1 \\ 0\end{matrix} ] , [ \begin{matrix}0 \\ 0\end{matrix} ] , [ \begin{matrix}1 \\ 0\end{matrix} ] , [ \begin{matrix}- 1 \\ 1\end{matrix} ] , [ \begin{matrix}0 \\ 1\end{matrix} ] , [ \begin{matrix}1 \\ 1\end{matrix} ] \} & ( 39 \text{-} 6 )\end{matrix}$$

Herein, when the image correlating potential force is not calculated, that is, the local optimization is not calculated, (when φ(n)=1), result of the local optimization yₘᵢₙ is set to yₘᵢₙ^{(m-1)}.

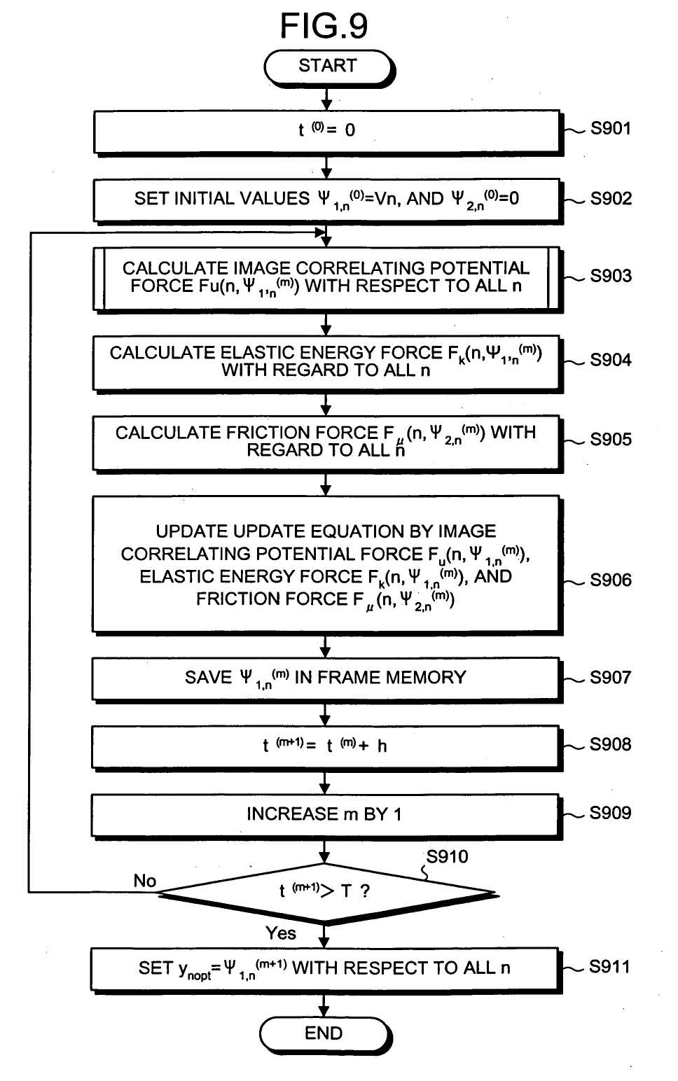

Next, the image matching process by the image matching apparatus 100 according to this embodiment configured as described above will be described. FIG. 9 is a flowchart showing procedures of the image matching process by the image matching apparatus 100. Specifically, the image matching process is realized by resolving the previously shown Equations (30-1) and (30-2) by the numeric analysis.

First, the solving process unit 101 set time t⁽⁰⁾=0 (step S901), and set initial values Ψ_{1,n}⁽⁰⁾=Vn, and Ψ_{2,n}⁽⁰⁾=0 (step S902). Thereby, Equation (30-2) is executed.

Next, the image correlating potential force Fᵤ(n, Ψ_{1,n}^{(m)}) is calculated with respect to all n by the image correlating potential force calculator 103 by using Equations (39-1) to (39-6) (step S903). The calculation process of such image correlating potential force Fᵤ(n, Ψ_{1,n}^{(m)}) will be described later.

Then, the elastic energy force Fₖ(n, Ψ_{1,n}^{(m)}) is calculated with respect to all n by the elastic energy force calculator 104 by using Equation (40) (step S904):

$${F}_{k} ( n , {Ψ}_{1 ,}^{( m )} ) = k ( {ψ}_{1 , n + [ \begin{matrix}0 \\ - 1\end{matrix} ]}^{( m )} - {ψ}_{1 , n}^{( m )} ) + k ( {ψ}_{1 , n + [ \begin{matrix}- 1 \\ 0\end{matrix} ]}^{( m )} - {ψ}_{1 , n}^{( m )} ) + k ( {ψ}_{1 , n + [ \begin{matrix}1 \\ 0\end{matrix} ]}^{( m )} - {ψ}_{1 , n}^{( m )} ) + k ( {ψ}_{1 , n + [ \begin{matrix}0 \\ 1\end{matrix} ]}^{( m )} - {ψ}_{1 , n}^{( m )} )$$

Further, the friction force F_{μ}(n, Ψ_{1,n}^{(m)}) is calculated with respect to all n, by the friction force calculator 105 by using Equation (41) (step S905):
F_{μ}(ψ_{2,n}^{(m)})=−μψ_{2,n}^{(m)} (41)

Next, update equation of Equation (30-1) is updated by the solving process unit 101 by using the image correlating potential force Fᵤ(n, Ψ_{1,n}^{(m)}) calculated in the step S903, the elastic energy force Fₖ(n, Ψ_{1,n}^{(m)}) found in the step S904, and the friction force F_{μ}(n, Ψ_{1,n}^{(m)}) found in the step S905 (step S906).

Then, the value of the point Ψ_{1,n}^{(m)} is saved in a frame memory 106 by the solving process unit 101 (step S907). Then, it is updated to t^{(m+1)}=t^{(m)}+h by the solving process unit 101 (step S908), thereby increasing n by 1 (step S909). Further, it is determined whether t^{(m+1)} excesses the predetermined time T or not (step S910), if not, the above-described steps S903 to S909 are repeatedly executed. On the other hand, when t^{(m+1)} excesses the time T, yₙₒₚₜ is set to Ψ_{1,n}^{(m)} relative to all n by the solving process unit 101 (step S911).

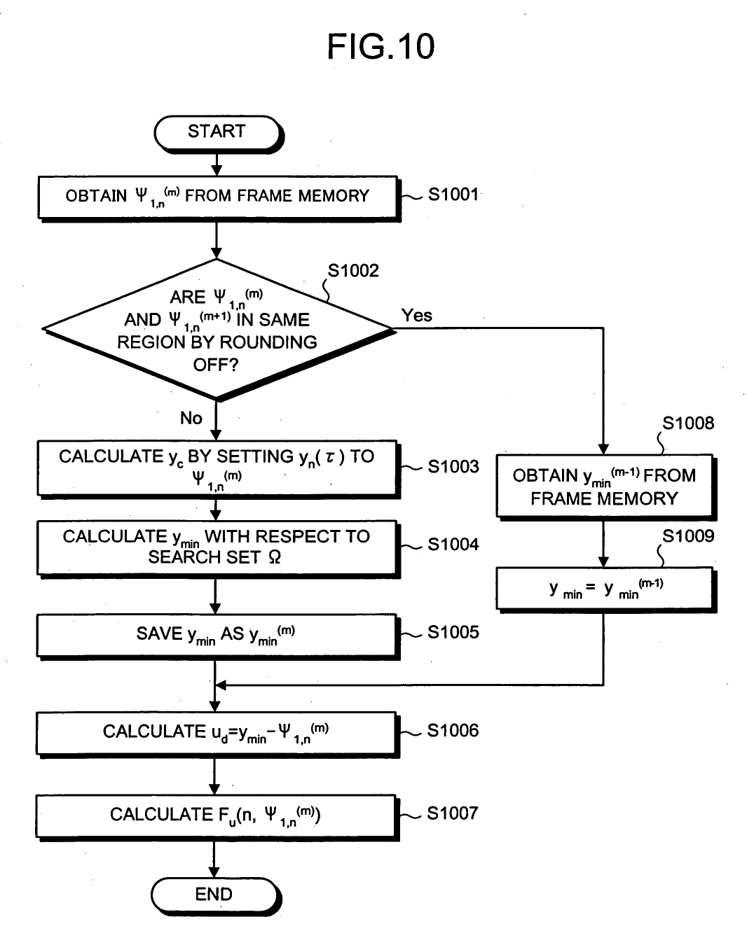

Next, the calculation process of the image correlating potential force in the step S903 is described. FIG. 10 is a flowchart showing procedures of the calculation process of the image correlating potential force according to the first embodiment. The image correlating potential force is calculated by using Equations (39-1) to (39-6).

First, Ψ_{1,n}^{(m)} is obtained from the frame memory 106 by the determination unit 102 (step S1001), and it is determined whether the points Ψ_{1,n}^{(m)} and Ψ_{1,n}^{(m+1)} are in the same region by rounding off or not, that is, whether the point Ψ_{1,n}^{(m+1)} is in the neighborhood of the latest pixel Ψ_{1,n}^{(m)} or not, by using Equation (37) (step S1002). Further, when the points Ψ_{1,n}^{(m)} and Ψ_{1,n}^{(m+1)} are in the same region by rounding off (when φ(n)=1), yₘᵢₙ^{(m-1)} is obtained from the frame memory 106 (step S1008), and result of the local optimization yₘᵢₙ is set to yₘᵢₙ(m−1) (step S1009).

Then, u_{d} is calculated by the image correlating potential force calculator 103 by using Equation (39-2) (step S1006), and the image correlating potential force Fᵤ(n, Ψ_{1,n}^{(m)}) is calculated by using Equation (39-1) (step S1007).

On the other hand, when the points Ψ_{1,n}^{(m)} and Ψ_{1,n}^{(m+1)} are not in the same region even by rounding off, in the step S1002 (when φ(n)=0), the local space center y_{c} is calculated by the image correlating potential force calculator 103 by using Equation (39-5) while setting the lattice point yₙ(τ) to Ψ_{1,n}^{(m)} (step S1003). Further, the result of the local optimization yₘᵢₙ is calculated with respect to the search set Ω represented by the equation (39-4) by the image correlating potential force calculator 103 (step S1004). Next, the result of the local optimization yₘᵢₙ is saved in the frame memory 106 as yₘᵢₙ^{(m)} by the image correlating potential force calculator 103 (step S1005).

Then, u_{d} is calculated by the image correlating potential force calculator 103 by using Equation (39-2) (step S1006), and the image correlating potential force Fᵤ(n, Ψ_{1,n}^{(m)}) is calculated by using Equation (39-1) (step S1007).

As described above, the image matching apparatus according to this embodiment determines whether the points Ψ_{1,n}^{(m)} and Ψ_{1,n}^{(m+1)} are in the same region by rounding off or not, that is, whether the point Ψ_{1,n}^{(m+1)} is in the neighborhood of the latest pixel Ψ_{1,n}^{(m)} or not, and when they are in the same region, the apparatus uses the last image correlating potential force without calculating the image correlating potential force, so that an efficient image matching process can be realized by reducing the calculation amount of the image matching process.

Further, since the equation of motion having the image correlating potential force, the elastic energy force and the friction force relative to the lattice point of the image is resolved in this embodiment, an efficient image matching process having simple structure and process thereof and extensibility, the process capable of realizing a high accurate process regardless of noise in the image and motion of the object can be realized, by improving robustness by minimizing an error by modeling of the image matching process and by reducing a calculation amount.

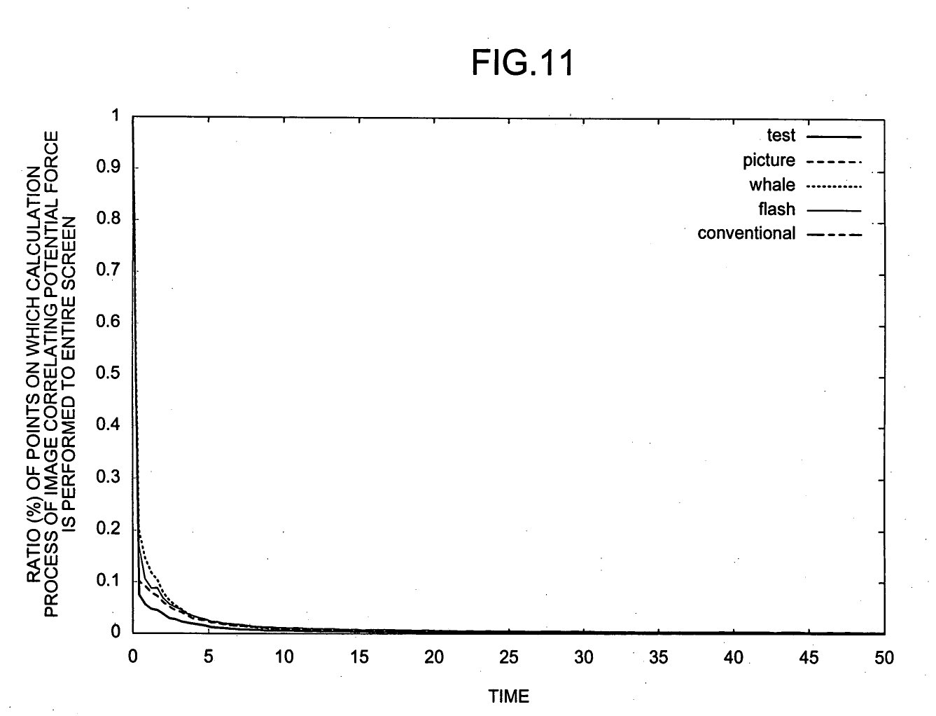

FIG. 11 is a graph showing a result of the image matching process of the first embodiment. In FIG. 11, a horizontal axis represents time and a vertical axis represents ratio of points on which the calculation process of the image correlating potential force is performed with respect to an entire screen relative to a plurality of image data, that is, the ratio (%) of the points, on which the calculation process of the image correlating potential cannot be skipped. As seen from FIG. 11, this shows reduction effect of the calculation amount, and as the graph dips, better calculation reducing effect appears. An actual calculation amount is obtained by integrating a curve of the graph in FIG. 11 by time, and is approximately 1%. This means that the calculation of the image correlating potential force is approximately 1% of the original calculation, and that a large calculation amount reducing effect is obtained. On the other hand, when the determination of execution of the calculation process of the image correlating potential force as in this embodiment is not performed, the reducing effect of the calculation amount does not appear, and the value of the vertical axis stays approximately 1%.

Next, a second embodiment will be described.

An image matching apparatus according to the second embodiment is configured to determine whether to perform the calculation of the image correlating potential force based on a difference between pixel values of the lattice point.

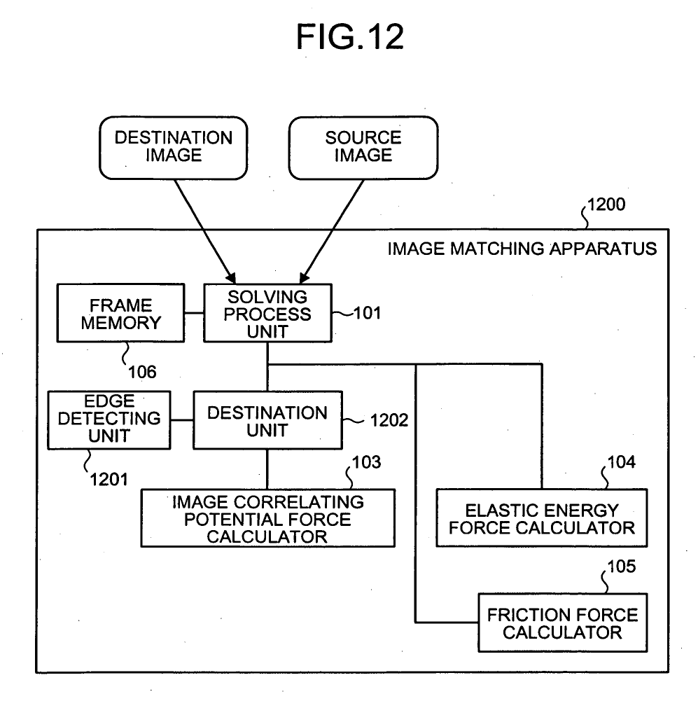

FIG. 12 is a block diagram showing a configuration of an image matching apparatus 1200 according to the second embodiment. The image matching apparatus 1200 of this embodiment is different from that of the first embodiment in that an edge detecting unit 1201 is provided, and a determination unit 1202 determines whether to perform the calculation of the image correlating potential force or not by the edge detecting unit 1201 according to an edge detecting result.

The edge detecting unit 1201 is configured to detect a difference between the pixel value of the lattice point of the source image and the pixel value of the lattice point of the time different from the time of the equation of motion of the lattice point, and detect an edge region in which the difference of the pixel values is not smaller than a predetermined threshold.

The determination unit 1202 determines not to skip the image correlating potential force calculation process when the edge region is detected by the edge detecting unit 1201, in addition to the same determination process as in the first embodiment.

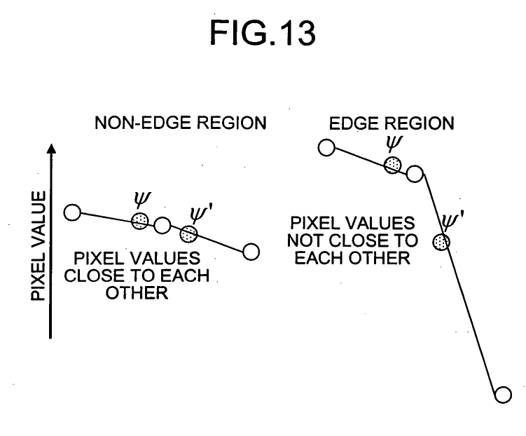

FIG. 13 is a schematic view showing a difference between the point Ψ(=Ψ_{1,n}^{(m)}) in the edge region and that in the non-edge region. In the first embodiment, determination process is performed on the assumption that the pixel value is close on the point Ψ′_{1,n}^{(m)} in the neighborhood of the point Ψ_{1,n}^{(m)}, but as shown in FIG. 13, in the edge region, the pixel value is not necessarily closely related even when the point Ψ′_{1,n}^{(m)} is in the neighborhood of the point Ψ_{1,n}^{(m)}. Therefore, on the point Ψ′_{1,n}^{(m)} in the neighborhood of the point Ψ′_{1,n}^{(m)}, it is not highly probable that a result of the local optimization is the same. So, in this embodiment, it is first determined whether the points Ψ_{1,n}^{(m)} and Ψ′_{1,n}^{(m)} are in the edge region or not, and, when they are in the edge region, the calculation process of the image correlating potential force is executed without skipping.

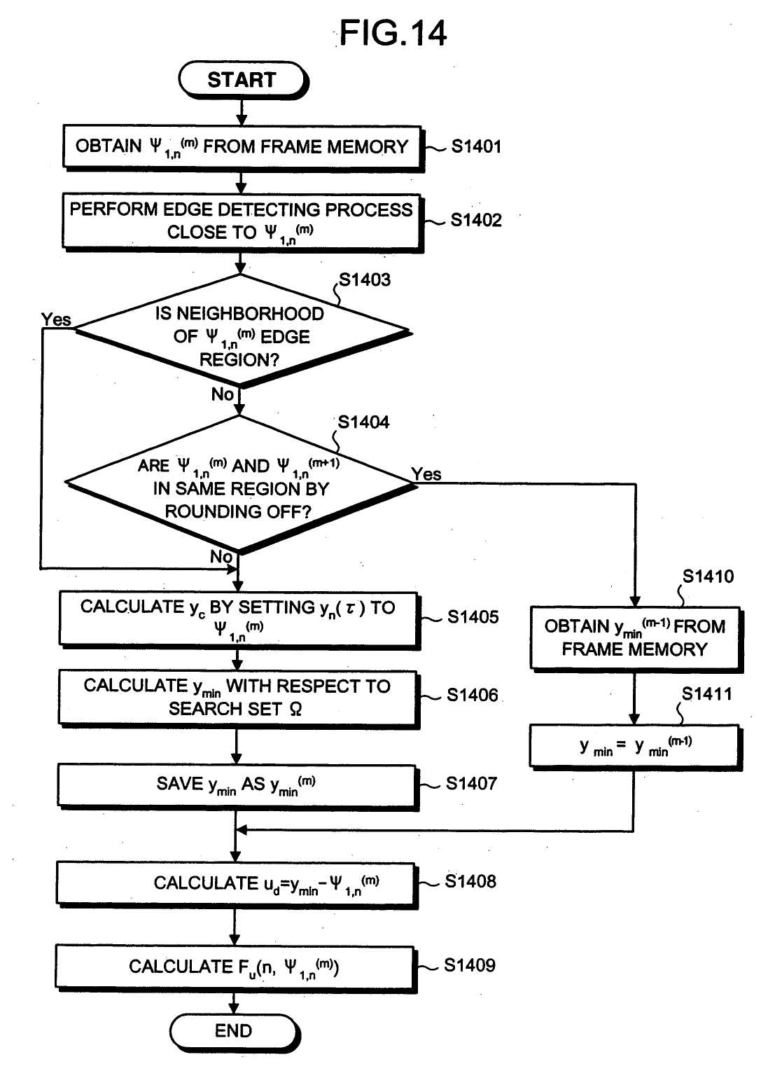

FIG. 14 is a flowchart showing procedures of the calculation process of the image correlating potential force according to the second embodiment.

First, Ψ′_{1,n}^{(m)} is obtained from the frame memory 106 by the edge detecting unit 1201 (step S1401), and detecting process of the edge region in the neighborhood of the point Ψ_{1,n}^{(m)} is performed (step S1402). The edge detecting process compares the pixel value of the point Ψ_{1,n}^{(m)} and that of the points in the neighborhood thereof, and when a difference of the pixel values is not smaller than the predetermined threshold, this is determined to be the edge region. For example, the edge detecting can be performed by using a differentiation operator by a convolution calculation.

Further it is checked whether the neighborhood of the point Ψ_{1,n}^{(m)} is the edge region or not in the result of the edge detecting process (step S1403).

When the neighborhood of the point Ψ_{1,n}^{(m)} is determined to be the edge region (step S1403: No), it is determined whether the points Ψ_{1,n}^{(m)} and Ψ_{1,n}^{(m+1)} are in the same region by rounding off or not, that is, whether the point Ψ_{1,n}^{(m+1)} is in the neighborhood of the latest pixel Ψ_{1,n}^{(m)} or not, by using Equation (37) (step S1404).

On the other hand, when it is determined not to be the edge region in the step S1403 (step S1403: Yes), the step S1404 process is skipped.

When the points Ψ_{1,n}^{(m)} and Ψ_{1,n}^{(m+1)} are in the same region by rounding off in the step S1404 (step S1404: Yes), the image correlating potential force calculation process in steps S1405 to S1407 to be described later is skipped, yₘᵢₙ^{(m-1)} is obtained from the frame memory 106 by the image correlating potential force calculator 103 (step S1410), and the local optimization result yₘᵢₙ is set to yₘᵢₙ^{(m-1)} (step S1411).

Further, u_{d} is calculated by the image correlating potential force calculator 103 by using the equation (39-2) (step S1408), and the image correlating potential force Fᵤ(n, Ψ_{1,n}^{(m)}) is calculated by using Equation (39-1) (step S1409).

On the other hand, when the points Ψ_{1,n}^{(m)} and Ψ_{1,n}^{(m+1)} are in not the same region by rounding off in the step S1404 (step S1404: No), the image correlating potential force calculation process is not skipped. Rest of the process is performed as in the first embodiment (steps S1405 to S1409).

As described above, in the image matching apparatus 1200 according to this embodiment, it is determined whether to perform the calculation of the image correlating potential force or not based on the difference between the pixel values of the lattice points, and the image correlating potential force calculation process is skipped when this is not in the edge region, so that it becomes possible to realize the image matching process with higher accuracy, while reducing the calculation amount of the image matching process.

Next, a third embodiment will be described.

An image matching apparatus according to the third embodiment is configured to determine whether to perform the calculation process of the image correlating potential force or not according to the elapse of time.

When the time τ is small, an entire lattice points moves relatively largely, so that it is preferable that a calculation of the image correlating potential energy force is not frequently skipped in this period of time.

However, as the time τ becomes larger, the entire lattice point does not move largely, so that a skip of the calculation process of the image correlating potential energy force does not largely affect the accuracy thereof.

Therefore, in this embodiment, it is determined whether to perform the calculation process of the image correlating potential force or not by using a size of the time τ.

A configuration of the image matching apparatus of this embodiment is similar to that in the first embodiment. In this embodiment, the determination unit 102 determines whether to execute the calculation process of the image correlating potential force by using the size of the time τ, in addition to the similar determination process as in the first and second embodiments.

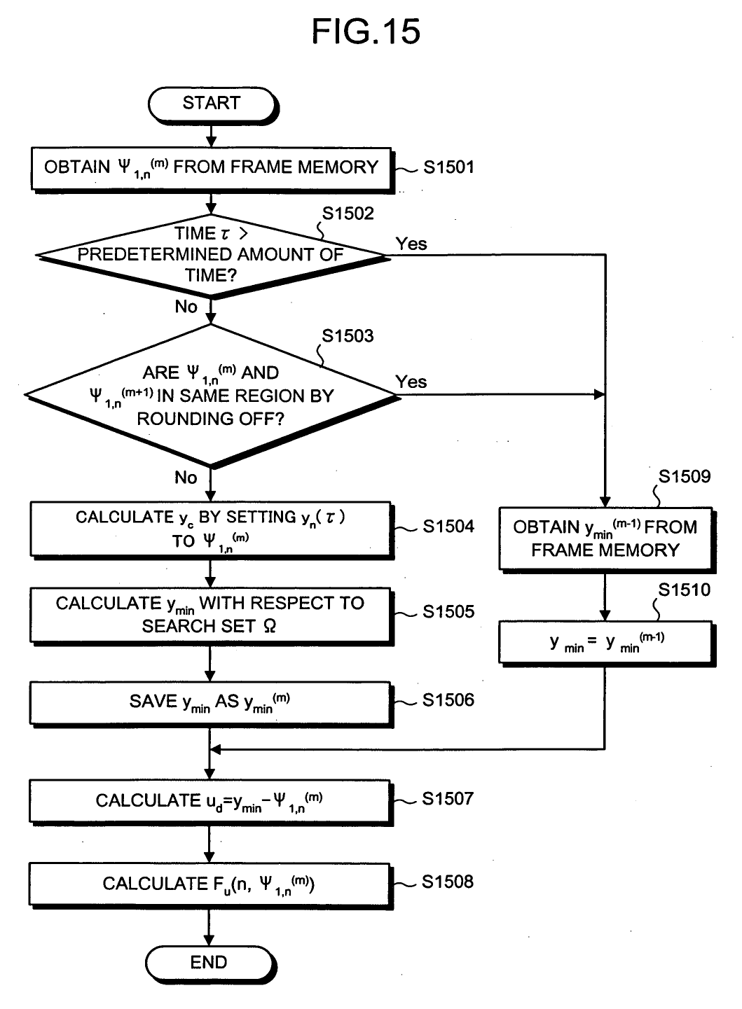

FIG. 15 is a flowchart showing procedures of the calculating process of the image correlating potential force according to the third embodiment.

First, the point Ψ_{1,n}^{(m)} is obtained from the frame memory 106 by the determination unit 102 (step S1501), and it is checked whether the time τ from a beginning of the image matching process is larger or not than a certain predetermined time (step S1502). Further when the time τ is larger than the certain predetermined time, yₘᵢₙ^{(m-1)} is obtained from the frame memory 106 by the image correlating potential force calculator 103 (step S1509), and the local optimization result yₘᵢₙ is set to yₘᵢₙ^{(m-1)} (step S1510).

Further, u_{d} is calculated by the image correlating potential force calculator 103 by using Equation (39-2) (step S1507), and the image correlating potential force Fᵤ(n, Ψ_{1,n}^{(m)}) is calculated by using the equation (39-1) (step S1508).

On the other hand, when it is determined that the time τ is not larger than the certain predetermined time in the step S1502, it is determined whether the points Ψ_{1,n}^{(m)} and Ψ_{1,n}^{(m+1)} are in the same region by rounding off or not, that is, whether the point Ψ_{1,n}^{(m+1)} is in the neighborhood of the latest pixel Ψ_{1,n}^{(m)} or not, by using Equation (37) (step S1503). Rest of the process is performed as in the first embodiment (steps S1504 to S1508).

As described above, in the image matching apparatus according to this embodiment, it is determined whether to perform the calculation process of the image correlating potential force according to the elapse of time, so that it is possible to realize the image matching process with high accuracy while reducing the calculation amount of the image matching process.

Meanwhile, it is possible to configure the apparatus so as to change the number of the lattice points, in which the image correlating potential force is calculated. For example, it is possible to configure the apparatus to predetermine a schedule such that the total number of the lattice points, on which the calculation of the image correlating potential is not performed, is reduced when the time τ is small, and the total number of the lattice points becomes larger as the time τ becomes larger, and to determine the lattice points on which the image correlating potential force is calculated by referring such schedule when performing image matching process. Further in this case, it is possible to adopt a configuration to determine at random the lattice points on which the image correlating potential force is not calculated.

Further, it is also possible to predetermine statistic information of motion of the lattice point, and determine whether to perform the calculation of the image correlating potential force or not by referring such statistic information. For example, it is possible to adopt a method to determine a region including a number of points which move largely and other region, and set a random probability not performing calculation of the image correlating potential force small, relative to the region in which the points largely move, and set the random probability large, relative to the region in which the number of points largely moves is statistically small.

Each image matching apparatus of the first to third embodiments is provided with a control unit such as a CPU, a memory device such as a ROM (Read Only Memory) and a RAM, an external memory device such as an HDD and a CD drive device, a display device such as a display, and an input device such as a keyboard and mouse, and has a hardware configuration using a normal computer.

The image matching program executed in the image matching apparatus of the first to third embodiments is stored in a recording media capable of being read by the computer, such as a CD-ROM, a flexible disk (FD), a CD-R, a DVD (Digital Versatile Disk), or the like, as a file capable of being installed or executed, and is provided.

Further, the image matching program executed in the image matching apparatus of the first to third embodiments may be configured to be stored in the computer connected to a network such as an internet and downloaded through the network and to be provided. Further the program of these embodiments (executed by the device according to these embodiments) may be configured to be provided or distributed through the network such as the internet.

Further, the image matching program of this embodiment may be configured to be provided by being incorporated in advance in a ROM or the like.

The image matching program to be executed in the image matching apparatus of the first to third embodiments has a configuration of module including above-described units (the solving process unit, the determination unit, the image correlating potential force calculator, the elastic energy force calculator, the friction force calculator, and the edge detecting unit), and as an actual hardware, the CPU (processor) reads out the image matching program from the above-described recording media and executes the same, thereby the above-described each unit (the solving process unit, the determination unit, the image correlating potential force calculator, the elastic energy force calculator, the friction force calculator, the edge detecting unit) is loaded on a main memory to be generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image matching apparatus, comprising:
a potential force calculator that calculates potential energy based on a correlating relationship of images between each of a plurality of first lattice points on a source image and each of a plurality of second lattice points corresponding one-to-one to the first lattice points on a destination image, and calculates potential force that the second lattice points receives by gradient of the potential energy based on a position of each of the second lattice points and a position of each of the first lattice points corresponding to the second lattice points;
a solving process unit that resolves an equation of motion of each of the second lattice points including the potential force by numeric analysis to obtain an convergence state of the second lattice points;
a determination unit that determines whether or not to execute a calculation process of the potential force for each of the second lattice points, based on a positional relationship between a current position being a position of a current time in the time of the equation of motion and a reference position being a position of a past time in the time of the equation of motion;
a mapping unit that obtains a correspondence relationship between the source image and the destination image based on the equilibrium state of the second lattice points,
wherein the potential force calculator sets the potential force calculated last time to the potential force of this time with respect to the second lattice points determined not to execute the calculation process of the potential force by the determination unit.

2. The image matching apparatus according to claim 1, further comprising:
an elastic energy force calculator that calculates elastic energy force received from elastic energy between each of the second lattice points and other second lattice points adjacent to the second lattice points,
wherein the solving process unit resolves the equation of motion regarding each of the second lattice points including the potential force and the elastic energy force by the numeric analysis to obtain the equilibrium state of the second lattice points.

3. The image matching apparatus according to claim 2, further comprising:
a friction calculator that calculates friction force acting on each of the second lattice points,
wherein the solving process unit resolves the equation of motion regarding each of the second lattice points including the potential force, the elastic energy force and the friction force, by the numeric analysis to obtain the equilibrium state of the second lattice points.

4. The image matching apparatus according to claim 3, wherein the determination unit determines not to execute the calculation process of the potential force, with respect to the second lattice points, the current position of which is in a predetermined range from the reference position.

5. The image matching apparatus according to claim 4, wherein the reference position is a position of the latest past time in the time of the equation of motion.

6. The image matching apparatus according to claim 4, wherein the determination unit determines not to execute the calculation process of the potential force with respect to the second lattice points in which a distance between the current position and the reference position is in a predetermined range.

7. The image matching apparatus according to claim 3, further comprising
an edge detecting unit for detecting a difference between a pixel value of the current position and the pixel value of the reference position with respect to the second lattice points,
wherein the determination unit determines not to execute the calculation process of the potential force with respect to the second lattice points in which the difference between the pixel values is smaller than a threshold.

8. The image matching apparatus according to claim 3, wherein the determination unit further determines whether to execute the calculation process of the potential force or not based on the elapse of time from an initial time to the current time in the time of the equation of motion.

9. The image matching apparatus according to claim 3, wherein the determination unit further determines whether to execute the calculation process of the potential force or not based on schedule information on a predetermined elapse of time from the initial time to the current time in the time of the equation of motion and propriety of execution of the calculation process of the potential force.

10. An image matching method, comprising:
calculating potential energy based on a correlating relationship of images between each of a plurality of first lattice points on the source image and each of a plurality of second lattice points corresponding one-to-one to the first lattice points on the destination image;
calculating potential force that the second lattice points receives by gradient of the potential energy based on a position of each of the second lattice points and a position of each of the first lattice points corresponding to the second lattice points;
resolving an equation of motion of each of the second lattice points including the potential force by numeric analysis to obtain an equilibrium state of the second lattice points;
determining whether to execute a calculation process of the potential force or not regarding each of the second lattice points, based on a positional relationship between a current position being a position of a current time in the time of the equation of motion and a reference position being a position-of a past time in the time of the equation of motion;
obtaining a correspondence relationship between the source image and the destination image based on the equilibrium state of the second lattice points,
wherein the potential force calculated last time is set to the potential force of this time, with respect to the second lattice points determined not to execute the calculation process of the potential force by the determination unit.

11. A computer program product having a computer readable medium including programmed instructions for matching images, wherein the instructions, when executed by a computer, cause the computer to perform:
calculating potential energy based on a correlating relationship of images between each of a plurality of first lattice points on the source image and each of a plurality of second lattice points corresponding one-to-one to the first lattice points on the destination image;
calculating potential force that the second lattice points receives by gradient of the potential energy based on a position of each of the second lattice points and a position of each of the first lattice points corresponding to the second lattice points;
resolving an equation of motion of each of the second lattice points including the potential force by numeric analysis to obtain an equilibrium state of the second lattice points;
determining whether to execute a calculation process of the potential force or not regarding each of the second lattice points, based on a positional relationship between a current position being a position of a current time in the time of the equation of motion and a reference position being a position of a past time in the time of the equation of motion;
obtaining a correspondence relationship between the source image and the destination image based on the equilibrium state of the second lattice points,
wherein the potential force calculated last time is set to the potential force of this time, with respect to the second lattice points determined not to execute the calculation process of the potential force by the determination unit.
